(19) United States
(12) Patent Application Publication
(10) Pub. No.: US 2022/0001870 A1
(43) Pub. Date: Jan. 6, 2022

(54) VEHICLE TRAVEL DIRECTION ESTIMATION DEVICE

(71) Applicant: TOYOTA JIDOSHA KABUSHIKI KAISHA, Toyota-shi (JP)

(72) Inventor: Hideaki BUNAZAWA, Nagoya-shi (JP)

(73) Assignee: TOYOTA JIDOSHA KABUSHIKI KAISHA, Toyota-shi (JP)

(21) Appl. No.: 17/360,208

(22) Filed: Jun. 28, 2021

(30) Foreign Application Priority Data
Jul. 3, 2020 (JP) 2020-115579

(51) Int. Cl. B60W 40/04

(52) U.S. Cl. CPC B60W 40/04; B60W 2554/4044; B60W 2510/182; B60W 2510/1005; B60W 2552/35; B60W 2540/10

(57) ABSTRACT

A vehicle travel direction estimation device includes a memory and a processor. The memory stores mapping data that prescribe mapping. The processor is configured to output, as an output variable, a travel direction variable that is a variable that indicates whether a vehicle is traveling forward or rearward. The mapping includes, as input variables, a front-rear acceleration variable that is a variable that indicates the acceleration of the vehicle in the front-rear direction and a vehicle speed variable that is a variable that indicates the travel speed of the vehicle or variations in the travel speed. The processor is configured to execute an acquisition process and a calculation process.

### CROSS-REFERENCE TO RELATED APPLICATION

This application claims priority to Japanese Patent Application No. 2020-115579 filed on Jul. 3, 2020, incorporated herein by reference in its entirety.

### BACKGROUND

### 1. Technical Field

The present disclosure relates to a vehicle travel direction estimation device.

### 2. Description of Related Art

A wheel speed sensor is attached to a wheel of a vehicle disclosed in Japanese Unexamined Patent Application Publication No. 2005-156209 (JP 2005-156209 A) to detect the rotational speed of the wheel. The wheel is also provided with an acceleration sensor that detects an acceleration of the wheel in the circumferential direction and a communication unit that transmits the result of detection by the acceleration sensor through wireless communication. A control device of the vehicle estimates the rotational direction of the wheel based on the acceleration of the wheel detected by the acceleration sensor and the state of acceleration and deceleration of the rotational speed of the wheel detected by the wheel speed sensor.

### SUMMARY

In the disclosure disclosed in JP 2005-156209 A, the acceleration sensor which detects an acceleration of the wheel in the circumferential direction is essential in order to estimate the rotational direction of the wheel, that is, whether the vehicle is traveling forward or rearward. When the acceleration sensor is mounted on the wheel, a peripheral device such as a wireless communication unit that wirelessly transmits the detection result is also necessary. Therefore, an increase in the cost is unignorable when implementing the disclosure disclosed in JP 2005-156209 A. Thus, there is desired a technique that allows accurate determination of whether the vehicle is traveling forward or rearward without necessarily providing a wheel with an acceleration sensor.

A first aspect of the present disclosure provides a vehicle travel direction estimation device including a memory and a processor. The memory stores mapping data that prescribe mapping. The processor is configured to output, as an output variable, a travel direction variable that is a variable that indicates whether a vehicle is traveling forward or rearward. The mapping includes, as input variables, a front-rear acceleration variable that is a variable that indicates an acceleration of the vehicle in a front-rear direction and a vehicle speed variable that is a variable that indicates a travel speed of the vehicle or variations in the travel speed. The processor is configured to execute an acquisition process in which values of the input variables are acquired and a calculation process in which a value of the output variable is calculated by inputting the values of the input variables acquired through the acquisition process to the mapping.

The front-rear acceleration and the travel speed of the vehicle may be used as information that indicates whether the vehicle is traveling forward or rearward. With the configuration described above, it is possible to accurately estimate whether the vehicle is traveling forward or rearward with a simple structure, in which the wheel is not provided with an acceleration sensor, by using mapping that includes such information as the input variables.

In the aspect described above, the input variables may include an accelerator operation amount variable that is a variable that indicates an amount of operation of an accelerator pedal of the vehicle. An acceleration is occasionally caused even if the amount of operation of the accelerator pedal is zero, such as in a phenomenon in which the vehicle travels rearward at the start of travel on a climbing road, or in a so-called slipping-down phenomenon, for example. Meanwhile, the acceleration of the vehicle in the front-rear direction is occasionally brought to zero, even if the amount of operation of the accelerator pedal is larger than zero, because of idling of the wheel due to bumps and pits on the road surface, for example. It is possible to estimate whether the vehicle is traveling forward or rearward in consideration of the travel state of the vehicle in various travel scenes based on the relationship between the accelerator operation amount variable and another variable when the input variables include the accelerator operation amount variable. Thus, it is possible to accurately estimate whether the vehicle is traveling forward or rearward in various travel scenes.

In the aspect described above, the input variables may include a shift range variable that is a variable that indicates a shift range of an automatic transmission of the vehicle. The shift range basically prescribes whether the vehicle is traveling forward or rearward. However, the travel direction of the vehicle is occasionally opposite to the direction prescribed by the shift range, such as when the vehicle slips down at the start of travel on a climbing road, for example. It is possible to estimate whether the vehicle is traveling forward or rearward in consideration of the travel state of the vehicle in various travel scenes based on the relationship between the shift range variable and another variable when the input variables include the shift range variable. Thus, it is possible to accurately estimate whether the vehicle is traveling forward or rearward in various travel scenes.

In the aspect described above, the input variables may include a road surface gradient variable that is a variable that indicates a gradient of a road surface on which the vehicle is traveling. There is a higher possibility that the vehicle slips down at the start of travel on a climbing road as the gradient of the road surface is larger, for example. It is possible to estimate whether the vehicle is traveling forward or rearward in consideration of the travel state of the vehicle which may occur in accordance with the magnitude of the gradient of the road surface when the input variables include the road surface gradient variable as in the configuration described above. Thus, it is possible to accurately estimate whether the vehicle is traveling forward or rearward in various travel scenes that may occur in association with the gradient of the road surface.

In the aspect described above, the input variables may include a braking variable that is a variable that indicates a braking force applied to a wheel by a braking device of the vehicle. The vehicle may slip down at the start of travel on a climbing road after braking applied to the wheel by the braking device is canceled. Thus, it is possible to estimate whether the vehicle is traveling forward or rearward in consideration of whether the vehicle is in a situation in which the vehicle may slip down, by adopting a variable indicating that braking applied by the braking device is switched off as the braking variable, for example. In this manner, it is possible to accurately estimate whether the vehicle is traveling forward or rearward in various travel scenes that may occur in association with braking applied to the wheel by the braking device when the input variables include the braking variable.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of a vehicle;

FIG. 2 is a flowchart illustrating the process procedure of a vehicle travel direction estimation process; and

FIG. 3 is a schematic diagram of a vehicle travel direction estimation system.

### DETAILED DESCRIPTION OF EMBODIMENTS

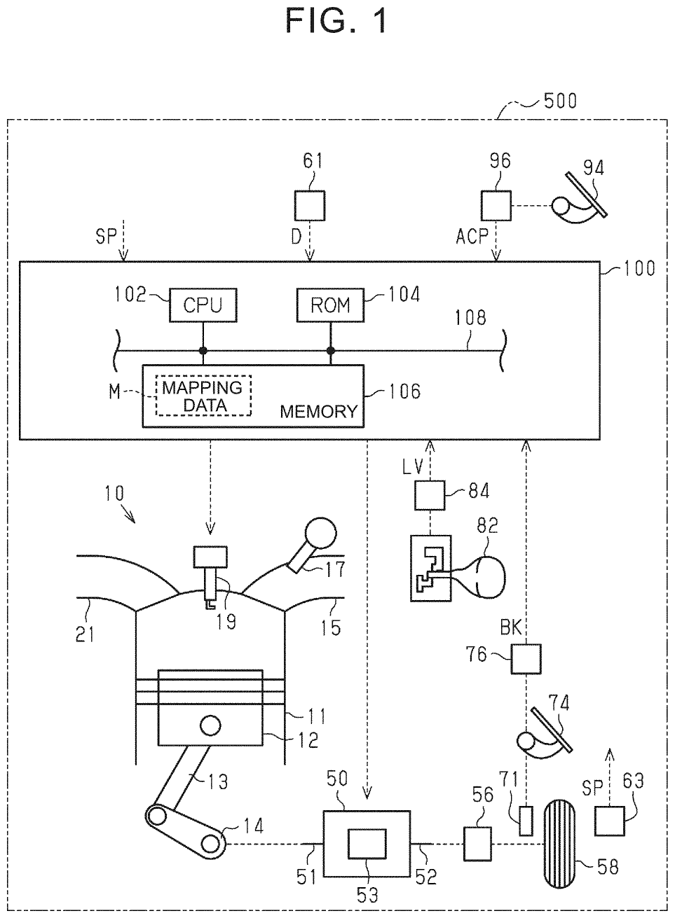

A vehicle travel direction estimation device according to an embodiment will be described below with reference to the drawings. First, a schematic configuration of a vehicle will be described. As illustrated in FIG. 1, an internal combustion engine 10 is mounted on a vehicle 500 to serve as a drive source of the vehicle 500. The internal combustion engine 10 has a cylinder 11 for combustion of a mixture of fuel and intake air. While a plurality of cylinders 11 is provided, only one of the cylinders 11 is illustrated in FIG. 1. A piston 12 is housed in the cylinder 11 so as to be reciprocally movable. The piston 12 is coupled to a crankshaft 14 via a connecting rod 13. The crankshaft 14 is rotated in accordance with reciprocal motion of the piston 12.

An intake passage 15 is connected to the cylinder 11 to introduce intake air from the outside into the cylinder 11. A fuel injection valve 17 is attached partway through the intake passage 15 to inject fuel. An exhaust passage 21 is connected to the cylinder 11 to discharge exhaust air in the cylinder 11 to the outside. The distal end of an ignition plug 19 is positioned in the cylinder 11 to ignite an air-fuel mixture in the cylinder 11.

An input shaft 51 of an automatic transmission 50 is coupled to the crankshaft 14 which is an output shaft of the internal combustion engine 10. An output shaft 52 of the automatic transmission 50 is coupled to a wheel 58 via a differential 56 etc. Although not illustrated in detail, a plurality of clutches and brakes as engagement elements 53 and a plurality of planetary gear mechanisms is interposed between the input shaft 51 and the output shaft 52 of the automatic transmission 50. In the automatic transmission 50, a shift speed that matches each shift range of the automatic transmission 50 is established by switching the disengagement/engagement state of each of the engagement elements 53. In the present embodiment, four shift ranges, namely a parking range, a neutral range, a drive range, and a reverse range, are set as a shift range SR. When the shift range SR is the parking range or the neutral range, a shift speed not for travel of the vehicle 500 is established in the automatic transmission 50. When the shift range SR is the drive range or the reverse range, a shift speed for travel of the vehicle 500 is established in the automatic transmission 50. Particularly, when the shift range SR is the drive range, a shift speed for forward travel of the vehicle 500 is established in the automatic transmission 50. When the shift range SR is the reverse range, a shift speed for rearward travel of the vehicle 500 is established in the automatic transmission 50.

A shift lever 82 is provided in the cabin of the vehicle 500 to switch the shift range SR of the automatic transmission 50. A shift position LV for each shift range SR is set as an operation position of the shift lever 82. Specifically, a parking position corresponding to the parking range, a reverse position corresponding to the reverse range, a neutral position corresponding to the neutral range, and a drive position corresponding to the drive range are set. A shift position sensor 84 is attached in the vicinity of the shift lever 82 to detect the shift position LV.

A brake 71 which is a braking device is attached to the wheel 58. A master cylinder that generates a hydraulic pressure in accordance with the amount of operation of a brake pedal 74 is connected to the brake 71, although not illustrated. The brake 71 brakes rotation of the wheel 58 in accordance with the hydraulic pressure generated by the master cylinder. A brake sensor 76 is attached in the vicinity of the brake pedal 74 to detect a brake operation amount BK which is the amount of operation of the brake pedal 74.

A vehicle speed sensor 63 is attached to the wheel 58 to detect a vehicle speed SP which is the travel speed of the vehicle 500. The vehicle speed sensor 63 detects the vehicle speed SP based on the rotational speed of the wheel 58. The vehicle speed sensor 63 detects the absolute value of the vehicle speed SP, since the vehicle speed sensor 63 cannot detect the rotational direction of the wheel 58. That is, the vehicle speed SP which is detected by the vehicle speed sensor 63 is equal to or more than zero, regardless of whether the wheel 58 is rotating forward or in reverse.

An acceleration sensor 61 is attached to the vehicle 500 to detect a front-rear acceleration D which is the acceleration of the vehicle 500 in the front-rear direction. If the gradient of a road surface on which the vehicle 500 is traveling is zero, the front-rear acceleration D which is detected by the acceleration sensor 61 is positive when the vehicle speed SP increases in the direction in which the vehicle 500 travels forward, and negative when the vehicle speed SP increases in the direction in which the vehicle 500 travels rearward.

An accelerator sensor 96 is attached to the vehicle 500 to detect an accelerator operation amount ACP which is the amount of operation of an accelerator pedal 94. Next, the control configuration of the vehicle 500 will be described.

Various types of control for the internal combustion engine 10, the automatic transmission 50, etc. are executed by a control device 100 mounted on the vehicle 500. The control device 100 may be constituted as one or more processors that execute various types of processes in accordance with a computer program (software). The control device 100 may be constituted as one or more dedicated hardware circuits such as application-specific integrated circuits (ASICs) that execute at least a part of the various types of processes, or circuitry that includes a combination of such circuits. The processor includes a central processing unit (CPU) 102 and a memory such as a random access memory (RAM) and a read only memory (ROM) 104. The memory stores program codes or instructions configured to cause the CPU 102 to execute the processes. The memory, which is a computer readable medium, includes any medium that can be accessed by a general-purpose or dedicated computer. The control device 100 has a memory 106 which is a non-volatile memory that is electrically rewritable. The CPU 102, the ROM 104, and the memory 106 can communicate with each other through an internal bus 108. In the present embodiment, the CPU 102 and the ROM 104 constitute a processor.

Mapping data M that prescribe mapping to which various types of input variables are input and which outputs an output variable are stored in the memory 106. In the present embodiment, the input variables include a front-rear acceleration variable which is a variable that indicates the front-rear acceleration D, a vehicle speed variable which is a variable that indicates variations in the vehicle speed SP, an accelerator operation amount variable which is a variable that indicates the accelerator operation amount ACP, and a shift range variable which is a variable that indicates the shift range SR of the automatic transmission 50. The specific content of the input variables will be discussed later. The output variable is a travel direction variable which is a variable that indicates whether the vehicle 500 is traveling forward or rearward. The specific content of the travel direction variable will be discussed later.

The CPU 102 can execute a vehicle travel direction estimation process to estimate whether the vehicle 500 is traveling forward or rearward. The CPU 102 implements various processes of the vehicle travel direction estimation process by executing a program stored in the ROM 104. The CPU 102 performs an acquisition process as a part of the vehicle travel direction estimation process. In the acquisition process, the CPU 102 acquires values of the input variables. The CPU 102 also performs a calculation process as a part of the vehicle travel direction estimation process. In the calculation process, the CPU 102 calculates a value of the output variable by inputting the values of the input variables acquired through the acquisition process to the mapping.

Detection signals from the various types of sensors attached to the vehicle 500 are input to the control device 100. Specifically, detection signals for the following parameters are input to the control device 100.
Front-rear acceleration D detected by the acceleration sensor 61
Vehicle speed SP detected by the vehicle speed sensor 63
Accelerator operation amount ACP detected by the accelerator sensor 96
Shift position LV detected by the shift position sensor 84
Brake operation amount BK detected by the brake sensor 76

Next, the vehicle travel direction estimation process will be discussed in detail.

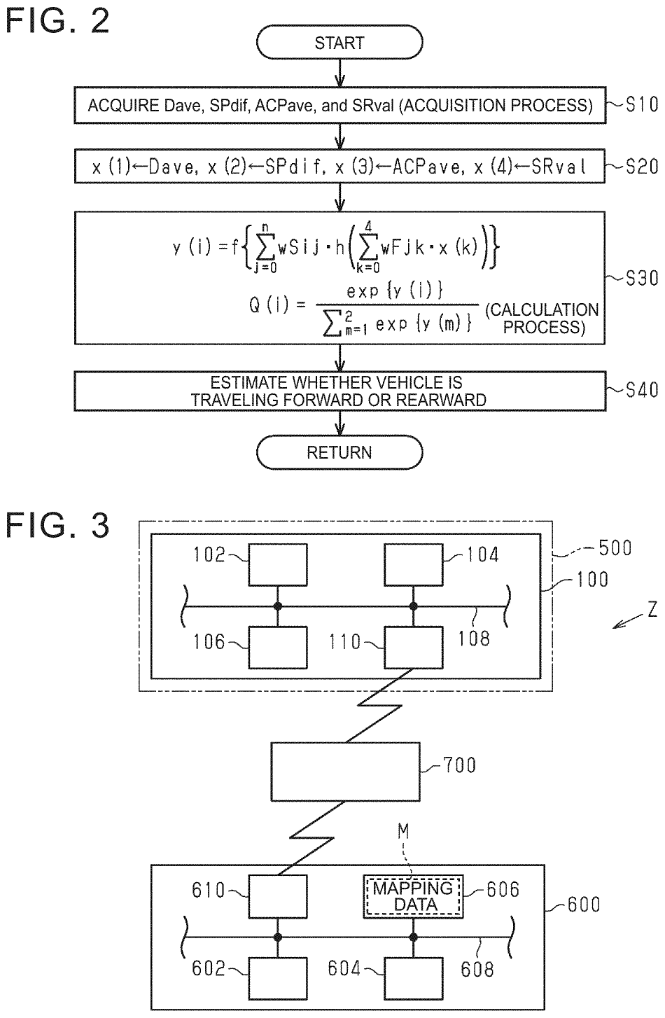

The CPU 102 executes the vehicle travel direction estimation process repeatedly in predetermined control cycles since an ignition switch of the vehicle 500 is turned on until the ignition switch is turned off. When the vehicle travel direction estimation process is started, as indicated in FIG. 2, the CPU 102 executes the process in step S10. In step S10, the CPU 102 acquires various types of variables that are necessary to estimate whether the vehicle 500 is traveling forward or rearward. The various types of variables are specifically an average acceleration value Dave, a vehicle speed difference value SPdif, an average accelerator operation amount value ACPave, and a shift range identification value SRval.

When a period since the last execution of the process in step S10 of the vehicle travel direction estimation process was finished until the process in step S10 is currently executed is defined as a data acquisition period, the average acceleration value Dave is the average value of the front-rear acceleration D for the data acquisition period. In the process in step S10, the CPU 102 references a series of data on the front-rear acceleration D which is input from the acceleration sensor 61 to the control device 100 during the data acquisition period, and calculates the average value of the front-rear acceleration D for the data acquisition period as the average acceleration value Dave. The CPU 102 calculating the average acceleration value Dave corresponds to the CPU 102 acquiring the average acceleration value Dave. The average acceleration value Dave is the front-rear acceleration variable described above.

The vehicle speed difference value SPdif is the amount of variation in the vehicle speed SP during the data acquisition period. In the process in step S10, the CPU 102 calculates a value obtained by subtracting the oldest vehicle speed SP from the latest vehicle speed SP during the data acquisition period as the vehicle speed difference value SPdif. The CPU 102 calculating the vehicle speed difference value SPdif corresponds to the CPU 102 acquiring the vehicle speed difference value SPdif. The vehicle speed difference value SPdif is the vehicle speed variable described above.

The average accelerator operation amount value ACPave is the average value of the accelerator operation amount ACP for the data acquisition period. In the process in step S10, the CPU 102 calculates an average accelerator operation amount value ACPave in the same manner as the average acceleration value Dave is calculated. The CPU 102 calculating the average accelerator operation amount value ACPave corresponds to the CPU 102 acquiring the average accelerator operation amount value ACPave. The average accelerator operation amount value ACPave is the accelerator operation amount variable described above.

The shift range identification value SRval is an identification value that indicates the present shift range SR of the vehicle 500. A numerical value for identification is allocated to each shift position LV of the shift lever 82. Specifically, “1” is allocated to the parking position, “2” is allocated to the neutral position, “3” is allocated to the drive position, and “4” is allocated to the reverse position. In the process in step S10, the CPU 102 references the latest shift position LV, and calculates a numerical value corresponding to the shift position LV as the shift range identification value SRval. The CPU 102 calculating the shift range identification value SRval corresponds to the CPU 102 acquiring the shift range identification value SRval. The shift range identification value SRval is the shift range variable described above.

When the acquisition of the average acceleration value Dave, the vehicle speed difference value SPdif, the average accelerator operation amount value ACPave, and the shift range identification value SRval in step S10 is finished, the CPU 102 proceeds to the process in step S20. The process in step S10 is the acquisition process.

In step S20, the CPU 102 substitutes the values of the variables which are acquired in the process in step S10 into input variables x(1) to x(4) to be input to the mapping described above as a pre-process for estimating, using the mapping, whether the vehicle 500 is traveling forward or rearward. Specifically, the CPU 102 substitutes the average acceleration value Dave into the input variable x(1), the vehicle speed difference value SPdif into the input variable x(2), the average accelerator operation amount value ACPave into the input variable x(3), and the shift range identification value SRval into the input variable x(4). After that, the CPU 102 proceeds to the process in step S30.

In step S30, the CPU 102 calculates output variables Q(1) to Q(2) by inputting the input variables x(1) to x(4) to the mapping which is prescribed by the mapping data M which are stored in the memory 106. The output variable Q(1) is a forward travel probability R1. The output variable Q(2) is a rearward travel probability R2. The forward travel probability R1 is obtained by quantifying the magnitude of the likelihood that the vehicle 500 is actually traveling forward as a value in the range of “0” to “1”. The rearward travel probability R2 is obtained by quantifying the magnitude of the likelihood that the vehicle 500 is actually traveling rearward as a value in the range of “0” to “1”.

In the present embodiment, the mapping is constituted from a fully-connected forward-propagation neural network with a single intermediate layer and a soft-max function that converts an output of the neural network. The neural network includes an input-side coefficient wFjk (j=0 to n, k=0 to 4) and an activation function h(x) as input-side non-linear mapping that performs a non-linear transform on each output of input-side linear mapping which is linear mapping prescribed by the input-side coefficient wFjk. In the present embodiment, a hyperbolic tangent “tan h(x)” is indicated as an example of the activation function h(x). The neural network also includes an output-side coefficient wSij (i=1 to 2, j=0 to n) and an activation function f(x) as output-side non-linear mapping that performs a non-linear transform on each output of output-side linear mapping which is linear mapping prescribed by the output-side coefficient wSij. In the present embodiment, a hyperbolic tangent “tan h(x)” is indicated as an example of the activation function f(x). A value n indicates the dimension of the intermediate layer. The input-side coefficient wFj0 is a bias parameter, and is a coefficient of the input variable x(0). The input variable x(0) is defined as “1”. The output-side coefficient wSi0 is a bias parameter.

The soft-max function is a function that brings the sum of the output variable Q(1) and the output variable Q(2) to “1” by normalizing the output of the neural network. The mapping prescribed by the mapping data M is a trained model trained using a vehicle of the same specifications as those of the vehicle 500 before being mounted on the vehicle 500. To train the mapping, teacher data and training data are acquired beforehand. That is, the vehicle 500 is caused to actually travel forward or rearward to generate true travel direction probability data as the teacher data. The travel direction probability data are constituted from a forward travel probability R1r and a rearward travel probability R2r. While the vehicle is traveling forward, the former is “1”, and the latter is “0”. While the vehicle is traveling rearward, meanwhile, the former is “0”, and the latter is “1”. In combination with the generation of such teacher data, the values of the various types of variables to be used as the input variables to be input to the mapping, such as the average acceleration value Dave, are acquired as the training data during travel of the vehicle. At this time, the values of the various types of variables are acquired using the same calculation method as that used to acquire various types of variables in step S10 of the vehicle travel direction estimation process. Sets of teacher data and training data are prepared for each of various travel scenes, such as when the vehicle slips down at the start of travel on a climbing road or when wheels are idling because of bumps and pits on the road surface, not to mention a general travel scene on a flat road. The mapping is trained using such teacher data and training data. That is, the input-side coefficient and the output-side coefficient are adjusted such that the difference between a value output from the mapping when the training data are input and the value of the teacher data which are the true travel direction probability for various travel scenes can be achieved. The training is completed when the above difference becomes equal to or less than a predetermined value.

In the process in step S30, the CPU 102 first calculates probability prototypes y(1) to y(2) which are outputs of the neural network prescribed by the input-side coefficient wFjk, the output-side coefficient wSij, and the activation functions h(x) and f(x). The probability prototype y(1) is a parameter that has a positive correlation with the probability that the vehicle 500 is traveling forward. The probability prototype y(2) is a parameter that has a positive correlation with the probability that the vehicle 500 is traveling rearward. When the probability prototypes y(1) to y(2) are calculated, the CPU 102 calculates output variables Q(1) to Q(2) by inputting the probability prototypes y(1) to y(2) to the soft-max function. After that, the CPU 102 proceeds to the process in step S40. The process in step S30 is the calculation process.

In step S40, the CPU 102 estimates whether the vehicle 500 is traveling forward or rearward based on the forward travel probability R1, which is the output variable Q(1), and the rearward travel probability R2, which is the output variable Q(2). Particularly, the CPU 102 performs the following determination process. That is, the CPU 102 determines that the vehicle 500 is traveling forward when the forward travel probability R1 is more than a threshold and the rearward travel probability R2 is less than the threshold. The threshold is “0.5”. The CPU 102 determines that the vehicle 500 is traveling rearward when the rearward travel probability R2 is more than the threshold and the forward travel probability R1 is less than the threshold. The CPU 102 determines that the vehicle 500 is not traveling forward or rearward, that is, the vehicle 500 is stationary, when both the forward travel probability R1 and the rearward travel probability R2 have the same value as the threshold. The CPU 102 temporarily ends the sequence of processes of the vehicle travel direction estimation process when the execution of the process in step S40 is finished. The CPU 102 executes the process in S10 again.

Next, the reason for adopting the front-rear acceleration variable, the vehicle speed variable, the accelerator operation amount variable, and the shift range variable as the input variables will be described as the function of the present embodiment. When it is assumed that the vehicle 500 is traveling on a flat road, for example, the vehicle 500 is either accelerating while traveling forward or decelerating while traveling rearward if the front-rear acceleration D detected by the acceleration sensor 61 has a positive value. At this time, the vehicle 500 is considered to be traveling forward if the vehicle speed SP detected by the vehicle speed sensor 63 is increasing. Meanwhile, the vehicle 500 is considered to be traveling rearward if the vehicle speed SP is reducing. The vehicle 500 is either decelerating while traveling forward or accelerating while traveling rearward if the front-rear acceleration D has a negative value. At this time, the vehicle 500 is considered to be traveling rearward if the vehicle speed SP is increasing. Meanwhile, the vehicle 500 is considered to be traveling forward if the vehicle speed SP is reducing. In this manner, variations in the front-rear acceleration D and the vehicle speed SP may be information that indicates whether the vehicle 500 is traveling forward or rearward. The front-rear acceleration variable and the vehicle speed variable are adopted as the input variables from such a point of view. In the present embodiment, the average acceleration value Dave is adopted as the front-rear acceleration variable in order to reduce the effect of an error and noise included in the front-rear acceleration D detected by the acceleration sensor 61. The vehicle speed difference value SPdif is adopted as the vehicle speed variable in order to grasp variations in the vehicle speed SP.

Various travel scenes may occur during travel of the vehicle 500, such as when the vehicle slips down at the start of travel on a climbing road or when the wheel 58 is idling because of bumps and pits on the road surface. The relationship between forward travel/rearward travel of the vehicle 500 and the front-rear acceleration D and the vehicle speed SP on a flat road described above may not be established depending on the travel scene of the vehicle 500. Thus, the travel direction of the vehicle 500 is preferably estimated in consideration of the travel state of the vehicle 500 in various travel scenes. In that event, the accelerator operation amount ACP and the shift range SR can be used as effective information.

For example, when the vehicle 500 is slipping down on a climbing road, the vehicle 500 accelerates while traveling rearward. At this time, the shift range SR is the drive range, and the accelerator operation amount ACP is zero. When the accelerator pedal 94 is depressed in order to cope with the slipping-down after the vehicle 500 slips down, the vehicle 500 decelerates while traveling rearward. When the accelerator pedal 94 is continuously depressed thereafter, the vehicle 500 accelerates while traveling forward. When the accelerator pedal 94 is released thereafter, the vehicle 500 decelerates while traveling forward. That is, in the series of travel scenes related to the slipping-down on a climbing road, the vehicle 500 may be accelerating while traveling rearward or decelerating while traveling forward if the shift range SR is the drive range and the accelerator operation amount ACP is zero. Meanwhile, the vehicle 500 may be decelerating while traveling rearward or accelerating while traveling forward if the shift range SR is the drive range and the accelerator operation amount ACP is larger than zero. It is possible to estimate whether the vehicle 500 is traveling forward or rearward based on the relationship among parameters that are suitable for the travel scenes, by estimating the travel direction of the vehicle 500 based on the above information in combination with the front-rear acceleration D and the vehicle speed SP. The accelerator operation amount variable and the shift range variable are adopted as the input variables from such a point of view. In the present embodiment, the average accelerator operation amount value ACPave is adopted as the accelerator operation amount variable in order to reduce the effect of an error and noise included in the accelerator operation amount ACP detected by the accelerator sensor 96. In order to grasp the shift range SR, the shift position LV is converted into a numerical form to be adopted as the shift range identification value SRval.

Next, the effect of the present embodiment will be described.

(1) It is important, in various types of control for the vehicle 500 such as control of a power transfer system from the internal combustion engine 10 to the wheel 58, to grasp whether the vehicle 500 is traveling forward or rearward. For example, drive torque of the wheel 58 required for travel of the vehicle 500 differs between when the vehicle 500 is traveling forward and when the vehicle 500 is traveling rearward. If drive torque of the wheel 58 differs, the magnitude of a hydraulic pressure that is necessary to maintain or switch the disengagement/engagement state of each of the engagement elements 53 of the automatic transmission 50 differs. If it is not possible to grasp whether the vehicle 500 is traveling forward or rearward, there may occur a situation in which a hydraulic pressure that is essentially necessary, which is determined based on drive torque required for travel of the vehicle 500, cannot be set. In this case, a high hydraulic pressure determined uniformly such that slipping of each of the engagement elements 53 can be suppressed must be used even when drive torque is considerably large, which increases a burden on an oil pump. Besides such a concern, there may also occur an issue that it is difficult to appropriately distribute torque to each wheel 58, for example, when it is not possible to grasp whether the vehicle 500 is traveling forward or rearward. With such a background, it is desired to accurately estimate whether the vehicle 500 is traveling forward or rearward.

As described in regard to the above function, forward travel and rearward travel of the vehicle 500 are associated with the variables such as the front-rear acceleration D and the vehicle speed SP. Thus, it is also conceivable to estimate whether the vehicle 500 is traveling forward or rearward using a map etc. that represents the relationship between forward travel and rearward travel of the vehicle 500 and the variables, rather than using mapping. However, it may be difficult to prepare a map that can support all travel scenes, and estimating the travel direction using such a map may complicate conditions for specifying various travel scenes, or significantly complicate the content of the processes performed by the CPU 102. On the other hand, it is costly to use an acceleration sensor in the wheel 58, as in JP 2005-156209 A, in order to avoid such apprehensions.

With the configuration described above, in this respect, mapping is used to estimate whether the vehicle 500 is traveling forward or rearward. By using mapping, it is possible to accurately estimate whether the vehicle 500 is traveling forward or rearward using detection values from various types of sensors commonly mounted on the vehicle 500. When estimating whether the vehicle 500 is traveling forward or rearward using mapping, a certain degree of accuracy can be secured if appropriate teacher data and training data can be prepared. Therefore, there is no need to take the trouble of setting complicated conditions for specifying various travel scenes or deriving complicated relational expressions.

(2) In the configuration described above, the input variables include the average acceleration value Dave and the vehicle speed difference value SPdif. As described in relation to the above function, the front-rear acceleration variable and the vehicle speed variable are variables associated with forward travel and rearward travel of the vehicle 500. Therefore, it is possible to accurately estimate whether the vehicle 500 is traveling forward or rearward when the input variables include the average acceleration value Dave which is a front-rear acceleration variable and the vehicle speed difference value SPdif which is a vehicle speed variable.

(3) In the configuration described above, the input variables include the average accelerator operation amount value ACPave. As described in relation to the above function, the accelerator operation amount variable may be information that indicates the travel scene of the vehicle 500. Therefore, it is possible to estimate whether the vehicle 500 is traveling forward or rearward in consideration of the travel state of the vehicle 500 in various travel scenes when the input variables include the average accelerator operation amount value ACPave, which is an accelerator operation amount variable, together with the average acceleration value Dave and the vehicle speed difference value SPdif. Thus, it is possible to accurately estimate whether the vehicle 500 is traveling forward or rearward in various travel scenes.

(4) In the configuration described above, the input variables include the shift range identification value SRval. As described in relation to the above function, the shift range variable may be information that indicates the travel scene of the vehicle 500, together with the accelerator operation amount ACP. Therefore, it is possible to estimate whether the vehicle 500 is traveling forward or rearward in consideration of the travel state of the vehicle 500 in various travel scenes when the input variables include the shift range identification value SRval which is a shift range variable, as with the accelerator operation amount ACP. Thus, it is possible to accurately estimate whether the vehicle 500 is traveling forward or rearward in various travel scenes.

The present embodiment may be modified as follows. The present embodiment and the following modifications can be combined with each other unless such an embodiment and modifications technically contradict with each other. For example, a part of the vehicle travel direction estimation process may be performed by a computer that is external to the vehicle 500. For example, a server 600 may be provided outside the vehicle 500 as illustrated in FIG. 3. The server 600 may be configured to perform the calculation process of the vehicle travel direction estimation process. In this case, the server 600 may be constituted as one or more processors that execute various types of processes in accordance with a computer program (software). The server 600 may be constituted as one or more dedicated hardware circuits such as application-specific integrated circuits (ASICs) that execute at least a part of the various types of processes, or circuitry that includes a combination of such circuits. The processor includes a CPU 602 and a memory such as a RAM and a ROM 604. The memory stores program codes or instructions configured to cause the CPU 602 to execute the processes. The memory, which is a computer readable medium, includes any medium that can be accessed by a general-purpose or dedicated computer. The server 600 has a memory 606 which is a non-volatile memory that is electrically rewritable. The memory 606 stores the mapping data M described in relation to the above embodiment. The server 600 has a communication unit 610 for connection to the outside of the server 600 through an external communication line network 700. The CPU 602, the ROM 604, the memory 606, and the communication unit 610 can communicate with each other through an internal bus 608.

When the calculation process of the vehicle travel direction estimation process is performed by the server 600, the control device 100 of the vehicle 500 has a communication unit 110 for communication with the outside of the control device 100 through the external communication line network 700. The configuration of the control device 100 is the same as that of the control device 100 according to the embodiment described above except for having the communication unit 110. Therefore, the control device 100 is not described in detail. Components in FIG. 3 with the same function as those in FIG. 1 are given the same reference signs as those in FIG. 1. The control device 100 and the server 600 constitute a vehicle travel direction estimation system Z.

When the calculation process of the vehicle travel direction estimation process is performed by the server 600, the control device 100 of the vehicle 500 first performs the acquisition process which is the process in step S10 according to the embodiment described above. When various types of variables are acquired through the process in step S10, the control device 100 transmits the acquired values of the various types of variables to the server 600. When the values of the various types of variables are received, the CPU 602 of the server 600 estimates whether the vehicle 500 is traveling forward or rearward by performing the processes in steps S20, S30, and S40 according to the embodiment described above. The CPU 602 of the server 600 performs the processes in steps S20, S30, and S40 by executing a program stored in the ROM 604.

When the control device 100 of the vehicle 500 and the server 600 perform the vehicle travel direction estimation process as in this modification, the CPU 102 and the ROM 104 of the control device 100 of the vehicle 500 and the CPU 602 and the ROM 604 of the server 600 constitute the processor.

All of the processes of the vehicle travel direction estimation process may be performed by a computer that is external to the vehicle 500. For example, when the server 600 is provided outside the vehicle 500 as in the modification described above, the control device 100 of the vehicle 500 transmits detection signals from the various types of sensors attached to the vehicle 500 to the server 600. The CPU 602 of the server 600 acquires the values of the various types of variables by performing a process corresponding to step S10 according to the embodiment described above. After that, the CPU 602 of the server 600 performs processes corresponding to steps S20, S30, and S40, as in the modification described above. In such a configuration, the server 600 performs the acquisition process and the calculation process.

The front-rear acceleration D and the accelerator operation amount ACP calculated to be input to the mapping in the process in step S10 are not limited to average values. For example, time-series data of detection signals input from the acceleration sensor 61 to the control device 100 during the data acquisition period may be subjected to a moving average filter etc. to calculate appropriate values. The same also applies to the accelerator operation amount ACP.

The front-rear acceleration D and the accelerator operation amount ACP calculated to be input to the mapping in the process in step S10 may be instantaneous values. For example, the latest values of the front-rear acceleration D and the accelerator operation amount ACP at the time of execution of step S10 may be calculated as values to be input to the mapping.

A differential value of the vehicle speed SP may be used, rather than using a detection signal from the acceleration sensor 61, to calculate the front-rear acceleration D to be input to the mapping in the process in step S10. When calculating the vehicle speed difference value SPdif in the process in step S10, time-series data of a detection signal input from the vehicle speed sensor 63 to the control device 100 may be subjected to a filter to calculate the amount of variation in the vehicle speed SP.

The variable adopted as the front-rear acceleration variable is not limited to that according to the embodiment described above. For example, an identification value that indicates whether the value detected by the acceleration sensor 61 is positive or negative, such as “1” if the front-rear acceleration D detected by the acceleration sensor 61 is positive and “0” if the front-rear acceleration D is negative, may be used as the front-rear acceleration variable. It is only necessary that the front-rear acceleration variable is a variable that indicates the front-rear acceleration D.

The vehicle speed variable which indicates variations in the vehicle speed SP is not limited to the vehicle speed difference value SPdif. For example, the vehicle speed variable may be the proportion of variations in the vehicle speed SP per unit time. The variable adopted as the vehicle speed variable is not limited to that according to the embodiment described above. For example, a variable that indicates the vehicle speed SP itself, rather than a variable that indicates variations in the vehicle speed SP, may be adopted as the vehicle speed variable. While the vehicle speed SP may become comparatively high when the vehicle 500 is traveling forward, the vehicle speed SP is not considered to become high when the vehicle 500 is traveling rearward. Thus, the vehicle speed SP itself may be used as an input variable for determining whether the vehicle 500 is traveling forward or rearward.

The variable adopted as the accelerator operation amount variable is not limited to that according to the embodiment described above. For example, an identification value that indicates the presence or absence of the accelerator operation amount ACP, such as “1” if the accelerator operation amount ACP is larger than zero and “0” if the accelerator operation amount ACP is zero, may be used as the accelerator operation amount variable. It is only necessary that the accelerator operation amount ACP is a variable that indicates the accelerator operation amount ACP.

The variable adopted as the shift range variable is not limited to that according to the embodiment described above. For example, the speed ratio of the automatic transmission 50 may be adopted as the shift range variable. In this case, a target speed ratio calculated by the control device 100 to control the automatic transmission 50 may be used, or the speed ratio may be calculated by actually measuring the rotational speeds of the input shaft 51 and the output shaft 52 of the automatic transmission 50. It is only necessary that the shift range variable is a variable that indicates the shift range.

The variables adopted as the various types of input variables may be variables that indicate stepped levels. For example, the accelerator operation amount ACP may be divided into a plurality of levels in accordance with the magnitude of the accelerator operation amount ACP, and values that indicate such levels may be adopted as the accelerator operation amount variable. The same also applies to the other input variables.

The types of the input variables are not limited to those according to the embodiment described above. Other input variables may be adopted in place of or in addition to those described in relation to the above embodiment. The number of input variables may be decreased from the number according to the embodiment described above. Any number of input variables may be used. However, the front-rear acceleration variable and the vehicle speed variable are essential as input variables.

The accelerator operation amount variable and the shift range variable are not essential as input variables. It is possible to calculate whether the vehicle 500 is traveling forward or rearward considerably precisely, even when such variables are not input, if the front-rear acceleration variable and the vehicle speed variable are included in the input variables.

Variables other than the variables described in relation to the above embodiment may be adopted as the input variables. The input variables may include a road surface gradient variable which is a variable that indicates the gradient of a road surface on which the vehicle 500 is traveling, for example. An estimated road surface gradient estimated based on a parameter that represents the travel state of the vehicle 500, such as the front-rear acceleration D or drive torque of the wheel 58, for example, may be adopted as the road surface gradient variable. Alternatively, an actually measured road surface gradient actually measured by a Global Positioning System (GPS) speedometer etc. may be adopted as the road surface gradient variable. Alternatively, a data road surface gradient determined in advance as map data may be adopted as the road surface gradient variable. In this case, roads are set by a plurality of nodes and links that connect between adjacent nodes in the map data. A data road surface gradient is set as the average inclination angle of a road surface for the extension direction of the road in the range from a specific node to an adjacent node. A data road surface gradient at the location at which the vehicle 500 is traveling can be calculated based on map data by acquiring the coordinate of the present position of the vehicle 500 by storing the map data in the memory 106 and providing the control device 100 with a GPS receiver.

There is a higher possibility that the vehicle slips down at the start of travel on a climbing road as the gradient of the road surface is larger. That is, the gradient of a road surface may be used as an index that indicates the likelihood that the vehicle 500 slips down. Thus, it is possible to estimate whether the vehicle 500 is traveling forward or rearward in consideration of the likelihood that the vehicle 500 slips down when the input variables include the road surface gradient variable. In this manner, it is possible to accurately estimate whether the vehicle 500 is traveling forward or rearward in various travel scenes that may occur in accordance with the magnitude of the gradient of the road surface, including the slipping-down on a climbing road, when the input variables include the road surface gradient variable.

The input variables may include a braking variable which is a variable that indicates a braking force applied to the wheel 58 by the braking device of the vehicle 500, for example. For example, a switching identification value that reflects switching between on and off of braking applied to the wheel 58 by the brake 71 may be adopted as the braking variable. Specifically, the switching identification value is set to “0”, which indicates that the braking force is zero, when braking applied by the brake 71 is switched off, and to “1”, which indicates that the braking force is positive, when braking applied by the brake 71 is switched on. It can be determined that braking applied by the brake 71 is switched off based on the fact that the brake operation amount BK is switched to zero from a value that is larger than zero. It can be determined that braking applied by the brake 71 is switched on based on the fact that the brake operation amount BK is switched from zero to a value that is larger than zero. The vehicle 500 slips down at the start of travel on a climbing road after braking applied by the brake 71 is canceled. That is, there is a high possibility that the vehicle 500 slips down when braking applied by the brake 71 is switched off. Thus, the switching identification value may be used as an index that indicates a situation in which the vehicle 500 may slip down. It is possible to more reliably grasp a situation in which the vehicle 500 may slip down when the input variables include such a switching identification value together with the road surface gradient variable. It is possible to estimate whether the vehicle 500 is traveling forward or rearward more accurately in a situation in which the vehicle 500 may slip down.

The input variables may include a turning state variable which is a variable that indicates the turning state of the vehicle 500, for example. An operation angle of a steering wheel, the acceleration of the vehicle 500 in the right-left direction, etc. may be adopted, for example, as the turning state variable. The turning state variable may be effective information for grasping the travel state of the vehicle 500 in various travel scenes.

The variable adopted as the travel direction variable is not limited to that according to the embodiment described above. The travel direction variable may be any variable that indicates whether the vehicle 500 is traveling forward or rearward. For example, the vehicle speed SP may be adopted as the travel direction variable. In this case, the vehicle speed SP may be set so as to have a positive or negative value, depending on whether the vehicle 500 is traveling forward or rearward, rather than detecting the absolute value of the vehicle speed SP. For example, the vehicle speed SP may be set so as to have a positive value when the vehicle 500 is traveling forward and have a negative value when the vehicle 500 is traveling rearward. The thus set vehicle speed SP may be used as a variable that indicates whether the vehicle 500 is traveling forward or rearward.

The configuration of the mapping is not limited to that according to the embodiment described above. For example, the neural network may include two or more intermediate layers. A recurrent neural network may be adopted as the neural network, for example. In this case, the values of the input variables in the past are reflected in the current calculation of a new value of the output variable, and thus such a neural network is suitable for estimating whether the vehicle 500 is traveling forward or rearward while reflecting the past history.

The method of acquiring training data and teacher data to be used to train the mapping data M is not limited to that according to the embodiment described above. For example, training data may be acquired by coupling the internal combustion engine and the automatic transmission to a chassis dynamometer to simulate a state in which the vehicle is actually traveling, rather than causing the vehicle to actually travel. In that event, various travel scenes may be simulated, such as by applying a load that is similar to that applied when the vehicle is traveling on an inclined road surface, for example.

The configuration of the vehicle 500 is not limited to that according to the embodiment described above. For example, not only the internal combustion engine 10 but also a motor may be mounted as a drive source of the vehicle 500. Alternatively, only a motor may be mounted as a drive source of the vehicle 500, in place of the internal combustion engine 10. A continuously variable transmission may be adopted as the automatic transmission.

What is claimed is:

1. A vehicle travel direction estimation device comprising:
a memory; and
a processor, wherein:
the memory stores mapping data that prescribe mapping;
the processor is configured to output, as an output variable, a travel direction variable that is a variable that indicates whether a vehicle is traveling forward or rearward;
the mapping includes, as input variables, a front-rear acceleration variable that is a variable that indicates an acceleration of the vehicle in a front-rear direction and a vehicle speed variable that is a variable that indicates a travel speed of the vehicle or variations in the travel speed; and
the processor is configured to execute an acquisition process in which values of the input variables are acquired and a calculation process in which a value of the output variable is calculated by inputting the values of the input variables acquired through the acquisition process to the mapping.

2. The vehicle travel direction estimation device according to claim 1, wherein the input variables include an accelerator operation amount variable that is a variable that indicates an amount of operation of an accelerator pedal of the vehicle.

3. The vehicle travel direction estimation device according to claim 1, wherein the input variables include a shift range variable that is a variable that indicates a shift range of an automatic transmission of the vehicle.

4. The vehicle travel direction estimation device according to claim 1, wherein the input variables include a road surface gradient variable that is a variable that indicates a gradient of a road surface on which the vehicle is traveling.

5. The vehicle travel direction estimation device according to claim 1, wherein the input variables include a braking variable that is a variable that indicates a braking force applied to a wheel by a braking device of the vehicle.
